(19) United States
(12) Patent Application Publication
(10) Pub. No.: US 2005/0017571 A1
(43) Pub. Date: Jan. 27, 2005

(54) Full face fabricated vehicle wheel and method for producing same

(76) Inventors: Patrick McCorry, Plymouth, MI (US); Miguel A. Garcia, McComb Township, MI (US)

Correspondence Address: MACMILLAN SOBANSKI & TODD, LLC;ONE MARITIME PLAZA FOURTH FLOOR, 720 WATER STREET, TOLEDO, OH, 43604-1619, US

(21) Appl. No.: 10/829,677

(22) Filed: Apr. 22, 2004

Related U.S. Application Data
(63) Continuation of application No. PCT/US02/19907, filed on Jun. 21, 2002.
(60) Provisional application No. 60/335,407, filed on Oct. 31, 2001.

(51) Int. Cl. B60B 3/10

(52) U.S. Cl. 301/64.101

(57) ABSTRACT

A full face fabricated vehicle wheel including a wheel rim and a wheel disc joined together by a suitable method. The wheel rim defines an axis and includes an inboard tire bead seat retaining flange, an inboard tire bead seat, an axially extending well, and an outboard tire bead seat. The outboard tire bead seat terminates at an endmost surface. The wheel disc includes a generally centrally located wheel mounting surface, a plurality of outwardly extending spokes, an outer annular portion and a plurality of decorative openings formed therein between each pair of spokes. Each of the spokes includes an inner end, and outer end, a rear wall, and a pair of opposed side walls. The inner end of the spokes is connected to the wheel mounting surface and the outer end of the spokes connected to the outer annular portion. The outer annular portion defines a continuous annular ring which defines an outboard tire bead seat retaining flange of the vehicle wheel.

### CROSS-REFERENCE TO RELATED APPLICATIONS

This application is a continuation of PCT/US02/19907, filed Jun. 21, 2002, which claims the benefit of U.S. Provisional Application Ser. No. 60/335,407, filed Oct. 31, 2001.

### BACKGROUND OF THE INVENTION

This invention relates in general to vehicle wheels and in particular to a full face fabricated vehicle wheel and method for producing the same.

A conventional fabricated vehicle wheel is typically of a two-piece construction and includes an inner disc and an outer “full” rim. The disc can be cast, forged, or fabricated from steel, aluminum, or other alloys, and includes an inner annular wheel mounting portion and an outer annular portion. The wheel mounting portion defines an inboard mounting surface and includes a center pilot or hub hole, and a plurality of lug receiving holes formed therethrough for mounting the wheel to an axle of the vehicle. The rim is fabricated from steel, aluminum, or other alloys, and includes an inboard tire bead seat retaining flange, an inboard tire bead seat, an axially extending well, an outboard tire bead seat, and an outboard tire bead seat retaining flange. In some instances, a three-piece wheel construction having a mounting cup secured to the disc is used. In both types of constructions, the outer annular portion of the disc is typically secured to the rim by welding.

A full face fabricated wheel is distinguished from other types of fabricated wheels by having a one-piece wheel disc construction. In particular, the full face wheel includes a “full face” disc and a “partial” rim. The full face disc can be formed cast, forged, or fabricated from steel, aluminum, or other alloys. The full face disc includes an inner annular wheel mounting portion and an outer annular portion which defines at least a portion of an outboard tire bead seat retaining flange of the wheel. The wheel mounting portion defines an inboard mounting surface and includes a center pilot or hub hole, and a plurality of lug receiving holes formed therethrough for mounting the wheel to an axle of the vehicle. The partial rim is fabricated from steel, aluminum, or other alloys, and includes an inboard tire bead seat retaining flange, an inboard tire bead seat, an axially extending well, and an outboard tire bead seat. In some instances, the outboard tire bead seat of the rim and the outer annular portion of the disc cooperate to form the outboard tire bead seat retaining flange of the full face wheel. In both types of constructions, the outboard tire bead seat of the rim is positioned adjacent the outer annular portion of the disc and a weld is applied to secure the rim and the disc together.

U.S. Pat. No. 6,042,194 to Fitz et al. discloses in FIGS. 4 and 5 a fabricated vehicle wheel having an outer full rim and an inner one piece disc having a plurality of spoke members. As shown in the Fitz et al. patent, in this embodiment each spoke member includes an outer end which is welded to the rim to produce the vehicle wheel. The Fitz et al. patent discloses other embodiments of a wheel construction having individual spoke members which are secured to the rim in a similar manner.

### SUMMARY OF THE INVENTION

This invention relates to an improved full face fabricated vehicle wheel including a wheel rim and a wheel disc which are joined together by a suitable method. The wheel rim defines an axis and includes an inboard tire bead seat retaining flange, an inboard tire bead seat, an axially extending well, and an outboard tire bead seat. The outboard tire bead seat terminates at an endmost surface. The wheel disc includes a generally centrally located wheel mounting surface, a plurality of outwardly extending spokes, an outer annular portion and a plurality of decorative openings formed therein between each pair of spokes. Each of the spokes includes an inner end, and outer end, a rear wall, and a pair of opposed side walls. The inner end of the spokes is connected to the wheel mounting surface and the outer end of the spokes connected to the outer annular portion. The outer annular portion defines a continuous annular ring which defines an outboard tire bead seat retaining flange of the vehicle wheel.

Other advantages of this invention will become apparent to those skilled in the art from the following detailed description of the preferred embodiments, when read in light of the accompanying drawings.

### BRIEF DESCRIPTION OF THE DRAWINGS

FIG. 1 is a plan view of a full face fabricated vehicle wheel produced in accordance with this invention.

FIG. 2 is a sectional view of the full face fabricated vehicle wheel of the present invention taken along line 2-2 of FIG. 1.

### DETAILED DESCRIPTION OF THE PREFERRED EMBODIMENT

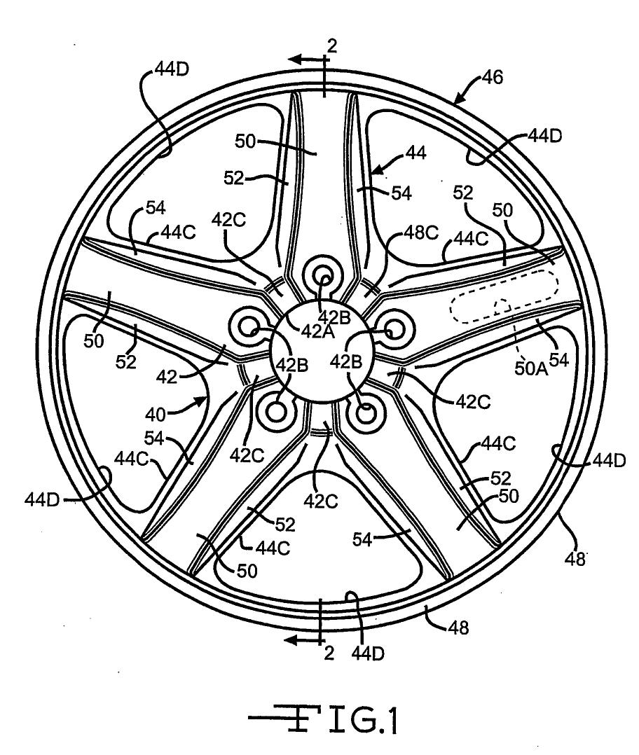

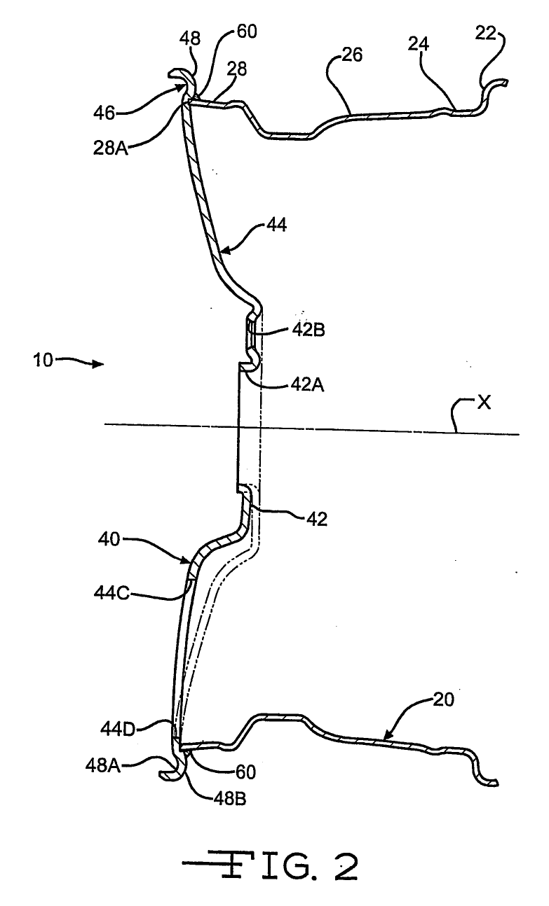

Referring now to the drawings, FIGS. 1 and 2 illustrate a vehicle wheel, indicated generally at 10, produced in accordance with the present invention. The vehicle wheel 10 produced according to this invention is illustrated as being a full face fabricated vehicle wheel. The full face fabricated vehicle wheel 10 includes a “partial” wheel rim 20 and a full face wheel disc 40 which are constructed and joined together in accordance with the present invention. The full face fabricated vehicle wheel 10 of the present invention defines a horizontal or longitudinal vehicle wheel axis X.

The wheel rim 20 is a fabricated wheel rim formed from a suitable material, such as for example, steel. The wheel rim 20 includes an inboard tire bead seat retaining flange 22, an inboard tire bead seat 24, a generally axially extending well 26, and an outboard tire bead seat 28. The outboard tire bead seat 28 terminates at an outermost end 28A. Alternatively, the wheel rim 20 can be formed from other materials, such as for example, magnesium, titanium, aluminum or alloys thereof.

The wheel disc 40 is a fabricated wheel disc formed from a suitable material, such as for example, steel. The wheel disc 40 includes a generally centrally located wheel mounting surface or portion 42, a plurality of outwardly extending spokes 44, and an outer annular portion 46. The outer annular portion 46 of the wheel disc 40 defines a continuous annular ring or band 48 which in turn defines an outboard tire bead seat retaining flange of the vehicle wheel 10. The outboard tire bead seat retaining flange 48 includes an outer surface 48A and an inner surface 48B, shown in FIG. 2.

In the illustrated embodiment, the wheel disc 40 includes five of such spokes 44 and the spokes 44, the wheel mounting surface 42 and the outer annular portion 46 are integral with one another. Alternatively, the number, shape and/or the construction of the spokes 44 can be other than illustrated if so desired. For example, the vehicle wheel 10 can include less than five spokes 44 or more than five spokes 44. Also, one or more of the spokes 44, the wheel mounting surface 42 and/or the outer annular portion 46 can be formed separate from the other components and joined thereto by a suitable method. For example, the spokes 44 and the wheel mounting surface 42 can be formed integral and joined to the outer annular portion 46; the spokes 44 and the outer annular portion 46 can be formed integral and joined to the wheel mounting surface 42; and the spokes 44, the wheel mounting surface 42, and the outer annular portion 46 can all be formed separate and joined together. Alternatively, the wheel disc 40 can be formed from other materials, such as for example, magnesium, titanium, aluminum or alloys thereof.

The wheel mounting surface 42 of the wheel disc 40 is provided with a centrally located pilot aperture 42A and a plurality of lug bolt receiving holes 42B circumferentially spaced around the pilot aperture 42A. In the illustrated embodiment, the wheel mounting surface 42 includes five of such lug bolt receiving holes 42B which are preferably provided in the wheel mounting surface 42 “in line” with a respective one of each of the five spokes 44. Alternatively, the number and/or the location of the lug bolt receiving holes 42B can be other than illustrated if so desired. The lug bolt receiving holes 42B receive lug bolts (not shown) and nuts (not shown) for securing the vehicle wheel 10 on an axle (not shown) of a vehicle.

The mounting surface 42 further includes a plurality of “strengthening” ribs 42C provided therein. In the illustrated embodiment, a rib 42C is located between each pair of lug bolt receiving holes 42B. Each of the ribs 42C is defined by a raised or embossed area which extends outwardly from or above the mounting surface 42. The ribs 42C are operative to strengthen the wheel mounting surface 42 to keep it from flexing during vehicle operation thereby improving the fatigue life of the associated vehicle wheel. Alternatively, the spacing, location, number and/or configuration of one or more of the ribs 42C can be other than illustrated and described if so desired.

The wheel disc 40 may also include one or more openings or windows 44C formed therein. In the illustrated embodiment, one of such windows 44C is provided between each pair of the spokes 44. Alternatively, the number and/or the location of the windows 44C can be other than illustrated if so desired.

Each of the spokes 44 of the wheel disc 40 includes a generally flat rear or back wall 50 and a pair of opposed side walls 52 and 54 extending outwardly from the rear wall 50. In the illustrated embodiment, the side walls 52 and 54 extend generally radially inwardly or non-parallel to one another and define a non-uniform or varying spoke width therebetween. Alternatively, the number and/or the configuration of one or more of the spokes 44 can be other than illustrated if so desired. For example, one or more of the spokes 44 can include an opening formed therein, such as an opening 50A shown in phantom in FIG. 1 in one of the spokes 44. Also, the side walls 52 and 54 could extend inwardly from the rear wall 50 and/or the side walls 52 and 54 could extend generally radially outwardly to one another to define a non-uniform spoke width therebetween or could extend generally parallel to one another to define a generally uniform spoke width therebetween.

To assemble the vehicle wheel 10, the outermost end 28A of the wheel rim 20 is positioned adjacent the inner surface 48B of the wheel disc 40 in a selected position and a circumferentially extending continuous, air-tight weld 60 is applied to secure the wheel rim 20 and wheel disc 40 together to produce the full face fabricated vehicle wheel 10 of the present invention. Preferably, the outermost end 28A of the wheel rim 20 and the inner surface 48B of the wheel disc 40 have a construction similar to that disclosed in U.S. Pat. No. 6,213,563 to Heck et al., the disclosure of which is incorporated by reference herein, to enable the wheel rim 20 and wheel disc 40 to be joined together as disclosed in the Heck et al. patent. Alternatively, other methods can be used to join the wheel rim 20 and the wheel disc 40 together if so desired.

One advantage of the present invention is that the size of the windows 44C of the full face fabricated vehicle wheel 10 are larger compared to those of a similar sized prior art fabricated vehicle wheel. This is due to one or more of the following factors: 1) the structure of the wheel disc 40, in particular the structure of the spokes 44; 2) the way that the wheel rim 20 and the wheel disc 40 are joined together; and/or 3) the structure of the wheel mounting surface 42 of the disc 40, in particular the ribs 42C. In particular, the windows 44C have a “high opening” in regards to the radial direction. The term high opening as used herein means that an outer periphery 44D of the windows 44C is located proximate the outboard tire bead seat retaining flange 48 of the wheel 10; the outer periphery 44D located just radially inwardly relative to the weld joint area.

In accordance with the provisions of the patent statues, the principle and mode of operation of this invention have been described and illustrated in its preferred embodiment. However, it must be understood that the invention may be practiced otherwise than as specifically explained and illustrated without departing from the scope or spirit of the attached claims.

1. A full face fabricated vehicle wheel comprising:
a wheel rim defining an axis and including an inboard tire bead seat retaining flange, an inboard tire bead seat, an axially extending well and an outboard tire bead seat, said outboard tire bead seat terminating at an endmost surface; and
a wheel disc joined to said wheel rim, said wheel disc including a generally centrally located wheel mounting surface, a plurality of outwardly extending spokes, an outer annular portion and a plurality of openings formed therein between each pair of said spokes, each of said spokes including an inner end, and outer end, a rear wall, and a pair of opposed side walls, said inner end of said spokes connected to said wheel mounting surface and said outer end of said spokes connected to said outer annular portion, said outer annular portion defining a continuous annular ring which defines an outboard tire bead seat retaining flange of the vehicle wheel.

2. The full face fabricated vehicle wheel according to claim 1 wherein said spokes, said wheel mounting surface and said outer annular portion are formed integral with one another.

3. The full face fabricated vehicle wheel according to claim 1 wherein said wheel mounting surface is provided with a centrally located pilot aperture and a plurality of lug bolt receiving holes circumferentially spaced around the pilot aperture.

4. The full face fabricated vehicle wheel according to claim 1 wherein a respective one of said lug bolt receiving holes is in line with a respective one of each of said spokes.

5. The full face fabricated vehicle wheel according to claim 1 wherein said wheel mounting surface further includes a plurality of ribs provided therein.

6. The full face fabricated vehicle wheel according to claim 1 wherein one of said ribs is located between each pair of said lug bolt receiving holes.

7. The full face fabricated vehicle wheel according to claim 1 wherein said side walls of said spokes extend generally non-parallel to one another to define a non-uniform spoke width therebetween.

8. The full face fabricated vehicle wheel according to claim 1 wherein at least one of said spokes includes at least one opening formed therein.

9. The full face fabricated vehicle wheel according to claim 1 wherein said wheel disc and said wheel rim are joined together by welding, and said opening formed between each of said pair of spokes includes an outer periphery located proximate said outboard tire bead seat retaining flange and just radially inwardly relative to the weld joint area to thereby provide a high window opening in the full face fabricated vehicle wheel.

10. A full face fabricated vehicle wheel comprising:
a wheel rim defining an axis and including an inboard tire bead seat retaining flange, an inboard tire bead seat, an axially extending well and an outboard tire bead seat, said outboard tire bead seat terminating at an endmost surface; and
a wheel disc joined to said wheel rim, said wheel disc including a generally centrally located wheel mounting surface, a plurality of outwardly extending spokes, an outer annular portion and a plurality of openings formed therein between each pair of said spokes, each of said spokes including an inner end, and outer end, a rear wall, and a pair of opposed side walls, said inner end of said spokes connected to said wheel mounting surface and said outer end of said spokes connected to said outer annular portion, said outer annular portion defining a continuous annular ring which defines an outboard tire bead seat retaining flange of the vehicle wheel, said spokes, said wheel mounting surface and said outer annular portion formed integral with one another, and said wheel mounting surface provided with a centrally located pilot aperture and a plurality of lug bolt receiving holes circumferentially spaced around the pilot aperture.

11. The full face fabricated vehicle wheel according to claim 10 wherein.

12. The full face fabricated vehicle wheel according to claim 10 wherein a respective one of said lug bolt receiving holes is in line with a respective one of each of said spokes.

13. The full face fabricated vehicle wheel according to claim 10 wherein said wheel mounting surface further includes a plurality of ribs provided therein.

14. The full face fabricated vehicle wheel according to claim 10 wherein one of said ribs is located between each pair of said lug bolt receiving holes.

15. The full face fabricated vehicle wheel according to claim 10 wherein said side walls of said spokes extend generally non-parallel to one another to define a non-uniform spoke width therebetween.

16. The full face fabricated vehicle wheel according to claim 10 wherein at least one of said spokes includes at least one opening formed therein.

17. The full face fabricated vehicle wheel according to claim 10 wherein said wheel disc and said wheel rim are joined together by welding, and said opening formed between each of said pair of spokes includes an outer periphery located proximate said outboard tire bead seat retaining flange and just radially inwardly relative to the weld joint area to thereby provide a high window opening in the full face fabricated vehicle wheel.

18. A full face fabricated vehicle wheel comprising:
a wheel rim defining an axis and including an inboard tire bead seat retaining flange, an inboard tire bead seat, an axially extending well and an outboard tire bead seat, said outboard tire bead seat terminating at an endmost surface; and
a wheel disc joined to said wheel rim, said wheel disc including a generally centrally located wheel mounting surface, a plurality of outwardly extending spokes, an outer annular portion and a plurality of openings formed therein between each pair of said spokes, each of said spokes including an inner end, and outer end, a rear wall, and a pair of opposed side walls, said inner end of said spokes connected to said wheel mounting surface and said outer end of said spokes connected to said outer annular portion, said outer annular portion defining a continuous annular ring which defines an outboard tire bead seat retaining flange of the vehicle wheel, said spokes, said wheel mounting surface and said outer annular portion formed integral with one another, said wheel mounting surface provided with a centrally located pilot aperture, a plurality of lug bolt receiving holes circumferentially spaced around the pilot aperture and a plurality of ribs provided therein;
wherein said wheel disc and said wheel rim are joined together by welding and said opening formed between each of said pair of spokes includes an outer periphery located proximate said outboard tire bead seat retaining flange and just radially inwardly relative to the weld joint area to thereby provide a high window opening in the full face fabricated vehicle wheel.

19. The full face fabricated vehicle wheel according to claim 18 wherein said side walls of said spokes extend generally non-parallel to one another to define a non-uniform spoke width therebetween.

20. The full face fabricated vehicle wheel according to claim 18 wherein at least one of said spokes includes at least one opening formed therein.
